(19) United States
(12) Patent Application Publication
(10) Pub. No.: US 2013/0198268 A1
(43) Pub. Date: Aug. 1, 2013

(54) GENERATION OF A MUSIC PLAYLIST BASED ON TEXT CONTENT ACCESSED BY A USER

(71) Applicant: David Hyman, Kensington, CA (US)

(72) Inventor: David Hyman, Kensington, CA (US)

(21) Appl. No.: 13/754,878

(22) Filed: Jan. 30, 2013

Related U.S. Application Data
(60) Provisional application No. 61/592,015, filed on Jan. 30, 2012.

(51) Int. Cl. H04L 29/06

(52) U.S. Cl. CPC H04L 67/42
USPC 709/203

(57) ABSTRACT

A method includes parsing, through a music server communicatively coupled to a client device, a text content of a blog and/or a social media feed accessed by a user of the client device. The method also includes generating, through the music server, a playlist including one or more song(s) related to the text content of the blog and/or the social media feed accessed by the user. Further, the method includes providing, through the music server, access to the generated playlist via the client device.

### CLAIM OF PRIORITY

This application is a conversion application and claims priority from the Provisional Application Ser. No. 61/592,015 titled GENERATION OF A PLAYLIST BASED ON A BLOG filed on Jan. 30, 2012.

### FIELD OF TECHNOLOGY

This disclosure relates generally to music service(s) and, more particularly, to generation of a music playlist based on text content accessed by a user.

### BACKGROUND

A user (e.g., a music fan, a critic, a music student) may read about music through a blog. A blog may be a website that may be periodically updated. The blog may include text articles, a comment section, website links and/or pictures. Further, the blog may include information related to a particular song and/or an artist of interest to the user.

The user may want to listen to songs associated with the blog (e.g., songs that are referenced, artists that may be referenced, music related to genre(s) referenced). For the aforementioned purpose, the user may have to copy song titles from the blog to enter into an interface associated with downloading the songs through a service (e.g., Apple® iTunes®). This may prove to be time consuming. Further, large amounts of music downloading may prove to be prohibitive with respect to cost. Still further, storing large amounts of downloaded music may be subjected to data storage limitations (e.g., laptop with limited storage space).

### SUMMARY

Disclosed are a method, a device and/or a system of generation of a music playlist based on text content accessed by a user.

In one aspect, a method includes parsing, through a music server communicatively coupled to a client device, a text content of a blog and/or a social media feed accessed by a user of the client device. The method also includes generating, through the music server, a playlist including one or more song(s) related to the text content of the blog and/or the social media feed accessed by the user. Further, the method includes providing, through the music server, access to the generated playlist via the client device.

In another aspect, a music server includes a memory, and a processor communicatively coupled to the memory. The processor is configured to execute instructions to parse a text content of a blog and/or a social media feed accessed by a user on a client device communicatively coupled to the music server. The processor is also configured to execute instructions to generate a playlist including one or more song(s) related to the text content of the blog and/or the social media feed accessed by the user, and to provide access to the generated playlist via the client device.

In yet another aspect, a system includes a client device, and a music server communicatively coupled to the client device. The music server is configured to parse a text content of a blog and/or a social media feed accessed by a user on the client device. The music server is also configured to generate a playlist including one or more song(s) related to the text content of the blog and/or the social media feed accessed by the user, and to provide access to the generated playlist via the client device.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF FIGURES

Example embodiments are illustrated by way of example and not limitation in the figures of the accompanying drawings, in which like references indicate similar elements and in which:

FIG. 1 is a schematic view of a playlist generation system, according to one embodiment.

FIG. 2 is a schematic view of a blog processing module of a music server of the playlist generation system of FIG. 1, according to one embodiment.

FIG. 3 is a schematic view of a user interface of a client device of the playlist generation system of FIG. 1, according to one embodiment.

FIG. 4 is a process flow diagram detailing the operations involved in generation of a music playlist based on text content accessed by a user, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of generation of a music playlist based on text content accessed by a user. Although the embodiments have been described with reference to specific example embodiments, it will be evident that various modifications and changes may be made to these embodiments without departing from the broader spirit and scope of the various embodiments.

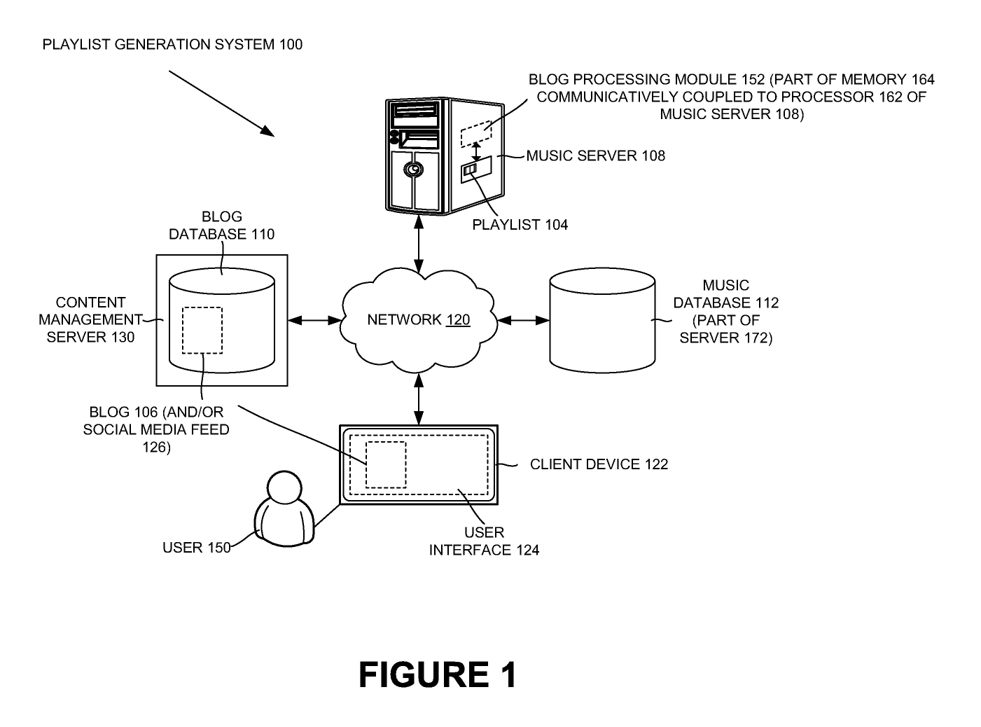

FIG. 1 shows a playlist generation system 100, according to one or more embodiments. In one or more embodiments, playlist generation system 100 may include a client device 122 (e.g., a desktop computer, a laptop computer, a notebook computer, a netbook, a mobile device such as a mobile phone, a portable music device) associated with a user 150. In one or more embodiments, user 150 may read and/or create a blog 106 (or, a website) through a user interface 124 (e.g., a web browser, an interface provided by a music service) on client device 122. Blog 106 may be periodically updated by an individual (e.g., user 150, another individual) or a group of individuals with regular entries of commentary, descriptions of events and/or material such as graphics and/or video therein. In one or more embodiments, user 150 may also access a social media feed 126 (e.g., Facebook® feed, an online forum feed) through user interface 124 (e.g., a web browser).

In one or more embodiments, client device 122 may be communicatively coupled to a music server 108 through a network 120 (e.g., a Local Area Network (LAN), Wide Area Network (WAN), Internet, satellite communication network). In one or more embodiments, music server 108 may be configured to generate a playlist 104 based on blog 106 and/or social media feed 126. In one or more embodiments, music server 108 may provide user 150 a capability to access playlist 104 through client device 122 (e.g., through user interface 124, through another interface therefor). In one or more embodiments, music server 108 may be associated with a music subscription service; therefore, playlist 104 may be provided as a service to user 150.

In one or more embodiments, blog 106 may be stored locally on client device 122 and/or remotely in a blog database 110. In one or more embodiments, in the case of remote storage, blog database 110 may be located in a content management server 130 configured to manage blogs analogous to and including blog 106. In one or more embodiments, content management server 130 may push blog content (including content of blog 106) to music server 108. For example, blog content may be distributed to music server 108 through a Rich Site Summary (RSS) feed. User 150 may access blog 106 from blog database 110 through network 120.

In one or more embodiments, music server 108 may execute a blog processing module 152 thereon (shown as a part of memory 164 communicatively coupled to processor 162 of music server 108). In one or more embodiments, blog processing module 152 may receive the blog content (and/or social media feed 126; through network 120) and generate playlist 104 based on the blog content (and/or social media feed 126). In one or more embodiments, blog processing module 152 may compare blog 106 and/or social media feed 126 to a music database 112 to generate playlist 104. In one or more embodiments, music database 112 may be part of music server 108 and/or another server 172 (FIG. 1 shows music database 112 as part of server 172). In one or more embodiments, music database 112 may be a master repository of music data such as songs, song title, artist name, genre and/or other metadata. In one or more embodiments, music database 112 may be accessible by client device 122 (and/or music server 108) through network 120.

In one or more embodiments, blog processing module 152 may process blog 106 (and/or social media feed 126) using natural language processing. Natural language processing may be the processing of human (natural) language such that the content and/or data of the natural language may be manipulated through a computer. For example, blog 106 may be written in a natural language to be processed such that the content of blog 106 may be manipulated to generate playlist 104 through music server 108.

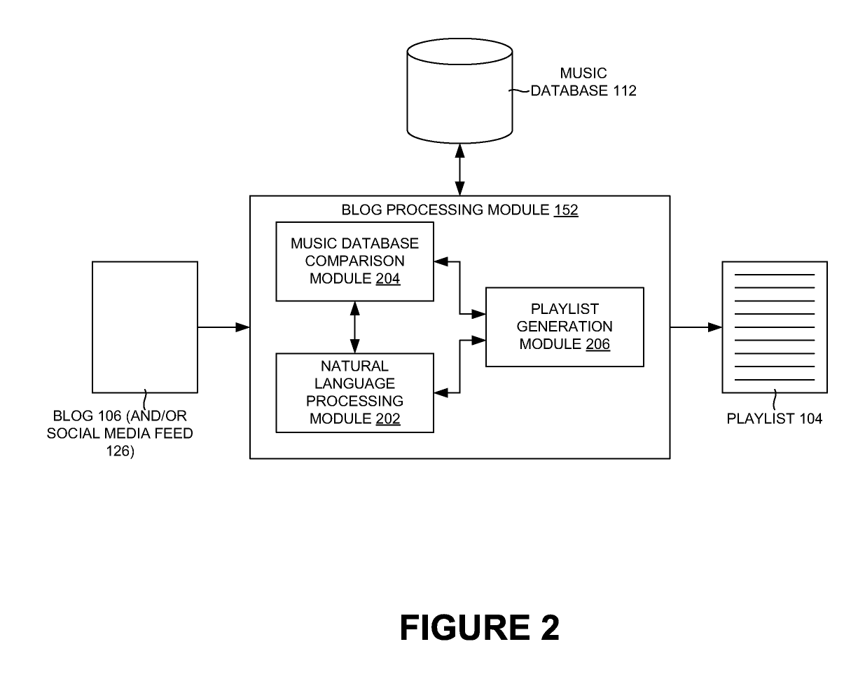

FIG. 2 shows blog processing module 152, according to one embodiment. In one or more embodiments, blog processing module 152 may include a natural language processing module 202, a music database comparison module 204 and a playlist generation module 206. In one or more embodiments, natural language processing module 202 may process the natural language of blog 106 (and/or social media feed 126) through an appropriate algorithm implemented therein. The aforementioned algorithm may utilize pattern recognition, for example, and may classify particular words or phrases of blog 106 (and/or social media feed 126) as song title, artist name, album name etc.

The algorithm may also possess a capability to process any erroneous input through blog 106 and/or social media feed 126 by way of misspelled words or words accidentally omitted. Further, the algorithm may implement named-entity recognition therethrough to include the classification of atomic elements in text (e.g., blog 106 and/or social media feed 126) into predefined categories such as names of persons, organizations, locations, expressions of times, quantities, monetary values, percentages, etc.

Still further, the algorithm may enable tagging a word and/or a phrase of blog 106 and/or social media feed 126. Natural language processing module 202 may, therefore, be capable of enabling comparing (e.g., through music database comparison module 204) the tagged word and/or the phrase of blog 106 and/or social media feed 126 to music database 112 including the name of an appropriate artist and/or an appropriate title of a song.

Also, natural language processing module 202 may be capable of parsing grammar of a sentence of blog 106 and/or social media feed 126 to enable determination of an artist name and/or song title. Further, natural language processing module 202 may employ word-sense disambiguation to determine the meaning of a word of blog 106 and/or social media feed 126. Contextual meaning of words may, therefore, be parsed. Other implementations of the algorithm discussed above are within the scope of the exemplary embodiments discussed herein.

In one or more embodiments, natural language processing module 202 may determine a particular song and/or artist mentioned in blog 106 and/or social media feed 126. For example, user 150 may indicate through blog 106 a liking for the particular song and/or the artist, which may be parsed through natural language processing module 202. In one or more embodiments, music database comparison module 204 may compare the language of blog 106 and/or social media feed 126 to the data in music database 112. For example, music database comparison module 204 may match a word and/or phrase of blog 106 and/or social media feed 126 with the corresponding artist name and/or song title in music database 112.

In one or more embodiments, playlist generation module 206 may generate playlist 104 based on the abovementioned parsing and comparison. In one or more embodiments, playlist 104 may include one or more songs; playlist 104 may be playable through accessing music database 112. A music file associated with a song may be in music database 112 and playlist 104 may include a pointer thereto.

In one or more embodiments, playlist 104 may be dynamically created as and when information is extracted from blog 106 and/or social media feed 126. Playlist 104 may be populated with songs related to content in blog 106 and/or social media feed 126. In addition, playlist 104 may be populated with songs that may not be expressly mentioned in the content of blog 106 and/or social media feed 126. For example, blog 106 may mention a certain artist, but not mention any song associated with that certain artist. Despite that, playlist 104 may be populated with songs by the certain artist.

In an example embodiment, a web radio (e.g., streamable) may be created (e.g., through music server 108) based on playlist 104. The web radio may play songs that are related to songs in playlist 104. For example, playlist 104 may include one song of a certain artist, but the web radio may play another song of the same certain artist. In another example embodiment, the web radio may play songs that are similar (e.g., similar in genre, tone, style, period) to the songs of playlist 104. In yet another embodiment, the web radio may play a song of an artist that is not listed in playlist 104. The web radio may merely play songs that capture the essence of blog 106 and/or social media feed 126.

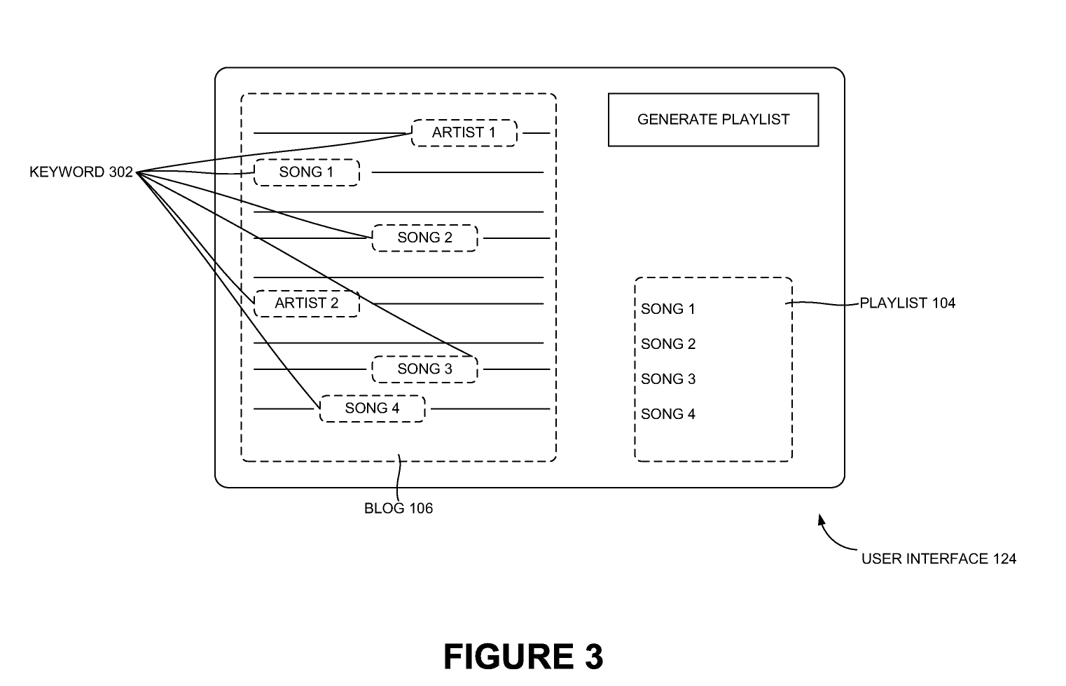

FIG. 3 shows user interface 124 of client device 122, according to one embodiment. As seen in FIG. 3, user interface 124 includes blog 106 (may also include social media feed 126) and/or playlist 104 generated through music server 108. Playlist 104 may include one or more songs based on blog 106, as discussed above. Blog 106 may include one or more keywords 302. A keyword 302 may be related to a particular song and/or a certain artist. Playlist 104 may be generated based on keywords 302 of blog 106.

Blog processing module 152 may process blog 106 such that one or more keywords 302 is determinable based on blog 106. The functioning of blog processing module 152 is discussed above. In one or more embodiments, user 150 may request generation of playlist 104 based on blog 106 and/or social media feed 126 through user interface 124 of client device 122. Alternately, in one or more embodiments, generation of playlist 104 through music server 108 may be automatically initiated during access of blog 106 and/or social media feed 126 by user 150. In other embodiments, music server 108 may provide a capability to user 150 to feed text content of blog 106 and/or social media feed 126 for parsing thereof and comparison with music database 112 to generate playlist 104.

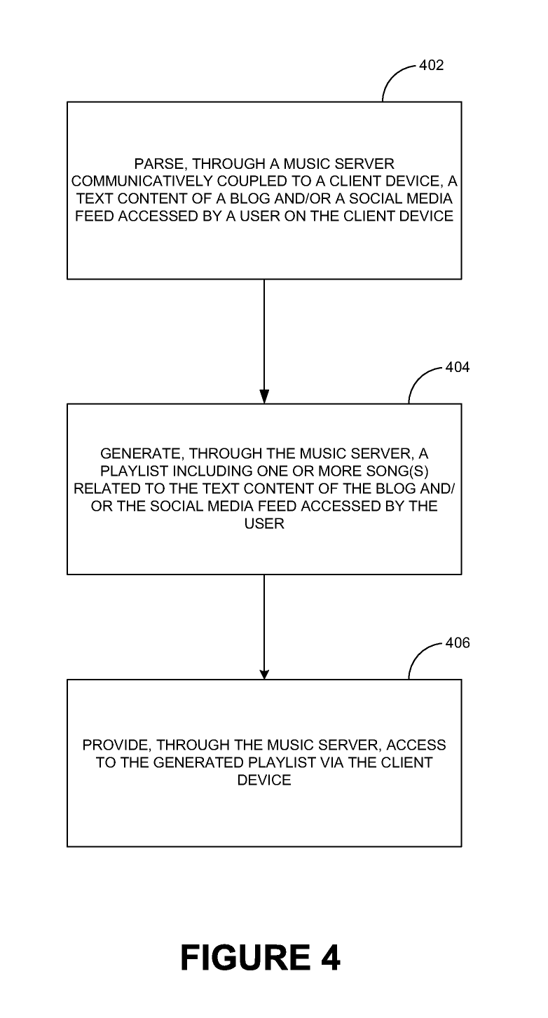

FIG. 4 shows a process flow diagram detailing the operations involved in generation of playlist 104 based on text content accessed by user 150, according to one or more embodiments. In one or more embodiments, operation 402 may involve parsing, through music server 108 communicatively coupled to client device 122, a text content of blog 106 and/or social media feed 126 accessed by user 150 on client device 122. In one or more embodiments, operation 404 may involve generating, through music server 108, playlist 104 including one or more song(s) related to the text content of blog 106 and/or social media feed 126 accessed by user 150. In one or more embodiments, operation 406 may then involve providing, through music server 108, access to the generated playlist 104 via client device 122.

An example scenario will now be described to which concepts associated with the exemplary embodiments are applicable. A music service provider (e.g., “XYZ Music Service”) may be accessed by user 150 through a computer terminal connected to the Internet. User 150 may be a frequent consumer of music in digital format (e.g., streamed music from the Internet, purchased downloads, music blogs). Additionally, user 150 may enjoy reading music blogs, where music may be discussed, critiqued, referenced and/or shared.

In an event where user 150 wishes to listen to all of the music described in a particular music blog (e.g., blog 106), XYZ Music Service may generate playlist 104 of the music mentioned in blog 106 and/or a playlist of music that is related to the music described in blog 106. XYZ Music Service may also function as a web radio so that user 150 may continuously listen to music that is related to blog 106. For example, XYZ Music Service may be embedded in the website that hosts blog 106.

XYZ Music Service may also be a service that user 150 subscribes to on an individual basis. In another example, user 150 may supply the blog text and/or website source to XYZ Music Service. User 150 may then be able to enjoy playlist 104 created based on the blog text and/or the website source by XYZ Music Service.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software or any combination of hardware, firmware, or software (e.g., embodied in a non-transitory machine-readable medium). For example, the various electrical structure and methods may be embodied using transistors, logic gates, and electrical circuits (e.g., application specific integrated (ASIC) circuitry or in Digital Signal Processor (DSP) circuitry).

In addition, it will be appreciated that the various operations, processes, and methods disclosed herein may be embodied in a machine-readable medium or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
parsing, through a music server communicatively coupled to a client device, a text content of at least one of a blog and a social media feed accessed by a user on the client device;
generating, through the music server, a playlist comprising at least one song related to the text content of the at least one of the blog and the social media feed accessed by the user; and
providing, through the music server, access to the generated playlist via the client device.

2. The method of claim 1, wherein generating the playlist through the music server further comprises matching the text content with a music database associated with the music server to extract the at least one song therefrom.

3. The method of claim 1, wherein the at least one song of the playlist is one of: directly related to the text content and indirectly related to the text content.

4. The method of claim 1, wherein the parsing of the text content is based on at least one of:
pattern recognition to classify at least one of a word and a phrase as being related to the at least one song,
processing erroneous content in the text content,
named-entity recognition,
at least one of word tagging and phrase tagging,
parsing grammar of a sentence of the text content,
word-sense disambiguation, and
parsing behavior of the user on the at least one of the blog and the social media feed.

5. The method of claim 2, wherein the client device, the music server and the music database are communicatively coupled to each other through a computer network.

6. The method of claim 1, further comprising providing, through the music server, the playlist as an executable radio station to the user at the client device.

7. The method of claim 1, further comprising providing, through the music server, a capability to the user to feed the text content of the at least one of the blog and the social media feed for parsing thereof.

8. A music server comprising:
a memory; and
a processor communicatively coupled to the memory, the processor being configured to execute instructions to:
parse a text content of at least one of a blog and a social media feed accessed by a user on a client device communicatively coupled to the music server,
generate a playlist comprising at least one song related to the text content of the at least one of the blog and the social media feed accessed by the user, and
provide access to the generated playlist via the client device.

9. The music server of claim 8, wherein the processor is further configured to execute instructions to generate the playlist through matching the text content with a music database associated with the music server to extract the at least one song therefrom.

10. The music server of claim 8, wherein the at least one song of the playlist is one of:
directly related to the text content and indirectly related to the text content.

11. The music server of claim 8, wherein the processor is configured to execute instructions related to the parsing of the text content based on at least one of:
pattern recognition to classify at least one of a word and a phrase as being related to the at least one song,
processing erroneous content in the text content,
named-entity recognition,
at least one of word tagging and phrase tagging,
parsing grammar of a sentence of the text content,
word-sense disambiguation, and
parsing behavior of the user on the at least one of the blog and the social media feed.

12. The music server of claim 8, wherein the processor is further configured to execute instructions related to providing the playlist as an executable radio station to the user at the client device.

13. The music server of claim 8, wherein the processor is further configured to execute instructions related to providing a capability to the user to feed the text content of the at least one of the blog and the social media feed for parsing thereof.

14. A system comprising:
a client device; and
a music server communicatively coupled to the client device, the music server being configured to:
parse a text content of at least one of a blog and a social media feed accessed by a user on the client device,
generate a playlist comprising at least one song related to the text content of the at least one of the blog and the social media feed accessed by the user, and
provide access to the generated playlist via the client device.

15. The system of claim 14, wherein the music server is configured to generate the playlist based on matching the text content with a music database associated therewith to extract the at least one song therefrom.

16. The system of claim 14, wherein the at least one song of the playlist is one of: directly related to the text content and indirectly related to the text content.

17. The system of claim 14, wherein the music server is configured to parse the text content based on at least one of:
pattern recognition to classify at least one of a word and a phrase as being related to the at least one song,
processing erroneous content in the text content,
named-entity recognition,
at least one of word tagging and phrase tagging,
parsing grammar of a sentence of the text content,
word-sense disambiguation, and
parsing behavior of the user on the at least one of the blog and the social media feed.

18. The system of claim 15, wherein the client device, the music server and the music database are communicatively coupled to each other through a computer network.

19. The system of claim 14, wherein the music server is further configured to provide the playlist as an executable radio station to the user at the client device.

20. The system of claim 14, wherein the music server is further configured to provide a capability to the user to feed the text content of the at least one of the blog and the social media feed for parsing thereof.
